(19) United States
(12) Patent Application Publication
(10) Pub. No.: US 2010/0142217 A1
(43) Pub. Date: Jun. 10, 2010

(54) LAMP

(75) Inventors: Markus Gerhard, Aachen (DE); Danijel Labas, Baesweiler (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/595,637

(22) PCT Filed: Apr. 14, 2008
(86) PCT No.: PCT/IB08/51408

§ 371 Date: Oct. 13, 2009

(30) Foreign Application Priority Data
Apr. 19, 2007 (EP) 07106484.4

(51) Int. Cl. F21V 7/00; H01R 24/00; H01R 13/00

(52) U.S. Cl. 362/516; 439/626; 439/485

(57) ABSTRACT

A lamp (10), particularly adapted for use as motor vehicle lamp, comprises a socket (12) made of a plastic material. The socket (12) may be adapted to support a burner for emitting light. The socket (12) comprises at least two connectors (22), by which the burner may be applied to an electric current. Each connector (22) comprises a terminal (24) protruding from the socket (12). According to the invention a metal cover (28) is provided, which receives the socket (12). The cover (28) comprises at least one opening (30) for providing an insulating space between the cover (28) and the terminals (24). Further the cover (28) is shaped to fit into a standardized holding recess of a reflector housing. Due to the design of the cover (28) the plastic material of the socket (12) may be significantly reduced and a good heat dissipation for the burner is provided, so that the lamp (10) is able to deal with a hot burner in a more cost efficient manner.

### FIELD OF THE INVENTION

The invention relates to the field of lamps, and more specifically to a motor vehicle lamp, like a high pressure discharge lamp or halogen lamp for use as motor vehicle headlight.

### BACKGROUND OF THE INVENTION

During use the temperature of a lamp increases. Especially a motor vehicle headlight becomes very hot, since the space for the burner inside the motor vehicle headlight is small and the burner of the motor vehicle headlight may be in use for a long time. This leads to a high temperature of the burner. For that reason the burner is normally supported by a socket made of plastic material, whereby the plastic material is selected with respect to a good heat resistance, for instance PPS (polyphenylene sulfide, (SC₆H₄)ₙ). Further the plastic material provides an electrical insulation, so that connectors for applying electric current to the burner are prevented from short current or the like. At the same time the plastic socket is shaped to fit into a standardized holding recess for connecting the lamp to a reflector housing of a motor vehicle. In WO 2005/017945 A2 such kind of a lamp is disclosed. However PPS and comparable materials are expensive leading to high production costs.

There is a permanent need to reduce production costs of the manufacture of lamps.

### SUMMARY OF THE INVENTION

It is an object of the invention to provide a lamp, which is able to deal with a hot burner in a more cost efficient manner.

This object is achieved by the features of claim 1. Preferred embodiments of the invention are given by the dependent claims.

The lamp according to the invention, particularly adapted for use as motor vehicle lamp, comprises a socket made of a plastic material, which is particularly selected with respect to a good heat resistance, for instance PPS (polyphenylene sulfide, (SC₆H₄)ₙ). The socket may be adapted to support a burner for emitting light. This support may be direct or indirect, for example via a metal holder connected to the burner and the socket. The socket comprises two or more, particularly three, connectors, by which the burner may be applied to an electric current. Each connector comprises a terminal protruding from the socket. Particularly the connectors may be mould in, for instance by injection molding of the plastic material of the socket, or mounted. According to the invention a metal cover is provided, which receives the socket. The cover comprises at least one opening for providing an insulating space between the cover and the terminals. Further the cover is shaped to fit into a standardized holding recess of a reflector housing.

Due to the high thermal conductivity of the metal cover heat concentrations can be avoided. Thus the heat from the burner is conducted via the socket to the metal cover, where the heat is distributed and transferred to the environment via the surface of the metal cover. Even at small building space the heat dissipation of the burner is increased. For providing a good heat transfer it is sufficient to made the cover of a cheap metal, like Aluminum. Since the connection of the lamp to a holding recess is provided by the cover instead of the socket, the plastic material of the socket may be significantly reduced. Thus, it is possible to save much of the plastic material leading to reduced production costs. Further the cover is particularly adapted to be manufactured by deed drawing. Thus, the cover may be shaped by deep drawing rendering a cost efficient production of the cover in an industrial scale possible. Since the cover is made from a metal material the cover improves the electromagnetic shied performance. Thus, it is possible to provide a significant increased voltage for an appropriate burner increasing the light radiation without increasing the electromagnetic radiation to the environment. Due to the opening for the terminals a short current between the connectors via the cover is prevented, so that the operability of the lamp is not affected. The shape and position of the opening is preferably selected such, that an electric short current or the like is prevented at every given tolerance in shape of the socket and the cover. Due to the ductility of the metal cover a shock resistance is provided, since the metal cover may provide a damping effect.

In a preferred embodiment the socket is at least partially encapsulated by the cover. The cover is particularly connected to the socket by a press fit, so that a continuous particularly planar contact between the cover and the socket may be provided defining the border of an encapsulated volume between the cover and the socket. By means of the cover ≧60% of the surface of the socket may be encapsulated. Further particularly ≧70%, preferably ≧80% and most preferred ≧85% of the surface of the socket is encapsulated by the cover. At high temperatures it is possible that gases may out-gas from the plastic material of the socket. Since most of the surface of the socket may be encapsulated, most gases out-gassed via the surface of the socket are encapsulated, too. Due to the encapsulating provided by the cover out-gassed gases are prevented from reaching the burner, a reflector of the lamp or the like. Thus the out-gassed material is prevented from affecting the optical performance of the lamp over the life-time of the lamp. Preferably the cover is gastight connected to the socket. However, since the out-gassed gases may condense after a short time at the cooler metal cover, a gastight connection is not absolute necessary to deal with most of the out-gassed materials.

In order to increase the heat transfer from the socket to the metal cover, the metal cover is preferably at least partially in planar contact to the socket. Due to the planar contact an out-gassing from the plastic material is further hampered or even prevented. In addition or in the alternate the metal cover preferably may comprise a cooling part for transferring heat from the burner to environment. The metal cover may comprise a cooling rib or a part providing a cooling like a cooling rib.

Preferably the cover is in direct contact to the plastic material of the socket only. An electrical insulation of the cover is safeguarded. The cover may be connected to the socket by press fitting and/or gluing and/or stitching and/or connecting means, for instance a clip connection.

For example the terminals are arranged one after the other in a line arranged substantially parallel to a longitudinal axis of the lamp. The terminals may be arranged spaced to each other and one upon the other in side view. Due to this arrangement of the terminals the lamp is shaped such, that the terminals of the lamp are adapted be come into electrical contact to a reflector housing by turning the lamp after inserting the lamp into a standardized holding recess. The lamp is particularly designed to fit the H 15 standard of motor vehicle lamps. In the alternate the lamp may be adapted to fit the H 8 standard, the H 9 standard, the H 11 standard or the like.

In a preferred embodiment the opening of the metal cover is shaped as slot. Due to this shape of the metal cover a single opening is sufficient to provide an insulating space between the cover and the terminals. Preferably the slot comprises an open end. This means the slot extends until the edge of the cover and/or is formed like a deep recess or cut in the cover. The open end of the slot may provide a movability of the cover substantially perpendicular to the terminals. The slot may be very narrow, if the terminals are arranged one after the other in a line. Thus, it is possible to slide the cover on the socket without meeting the terminals during the assembling of the lamp.

Due to the cover the plastic material of the socket may be reduced significantly. Preferably the plastic material of the socket only consists of a connector part for fixing the connectors and the terminals in an insulating manner to each other, a holding part for supporting directly or indirectly the burner and at least one connecting means for connecting the cover to the socket. Thus it is possible to reduce the plastic material and the possibility of out-gassed materials of the plastic material to a minimum. It is even possible to further omit the connecting means of the socket. For example the cover may be connected to the socket by being mould in or by friction only provided by a press fit. Most preferred the plastic material of the socket only consists of a connector part for fixing the connectors and the terminals in an insulating manner to each other and a holding part for supporting directly or indirectly the burner. For example the holding part may be disk-like for receiving a holder or the burner and the connector part may protrude from the disk-like holding part comprising the mould in connectors. The cover may be in direct contact to a circumferential surface of the disk-like holding part as well as to the holding part without contact to the protruding terminals. This design leads to a simple structure leading to reduced production costs.

The invention further relates to a motor vehicle lamp arrangement comprising a reflector housing and a lamp. The reflector housing comprises a standardized holding recess, by which a motor vehicle lamp, particularly of the H 15 standard, may be received. The lamp, which particularly may be a headlight, main beam or taillight, may be designed as previously described. The reflector housing and the lamp are shaped such, that the terminals of the lamp are adapted be come into electrical contact to the reflector housing by turning the lamp after inserting the lamp into the standardized holding recess. Thus, it is sufficient first to put the lamp into the recess by a movement of the lamp in axial direction and subsequent to provide electrical contact by turning the lamp in circumferential direction. The connection may be of the bayonet type. Since the connection of the lamp to the housing is provided by the cover only, the plastic material of the socket do not have to provide a connecting function, so that the design of the plastic material of the socket may be significantly simplified particularly with respect to a material reduction.

### BRIEF DESCRIPTION OF THE DRAWINGS

These and other aspects of the invention will be apparent from and elucidated with reference to the embodiments described hereinafter.

In the drawings:

FIG. 1 is a perspective exploded view of a lamp according to the invention,

FIG. 2 is a perspective view of the lamp illustrated in FIG. 1 in assembled state and

FIG. 3 is a sectional side view of the lamp illustrated in FIG. 2

### DETAILED DESCRIPTION OF EMBODIMENTS

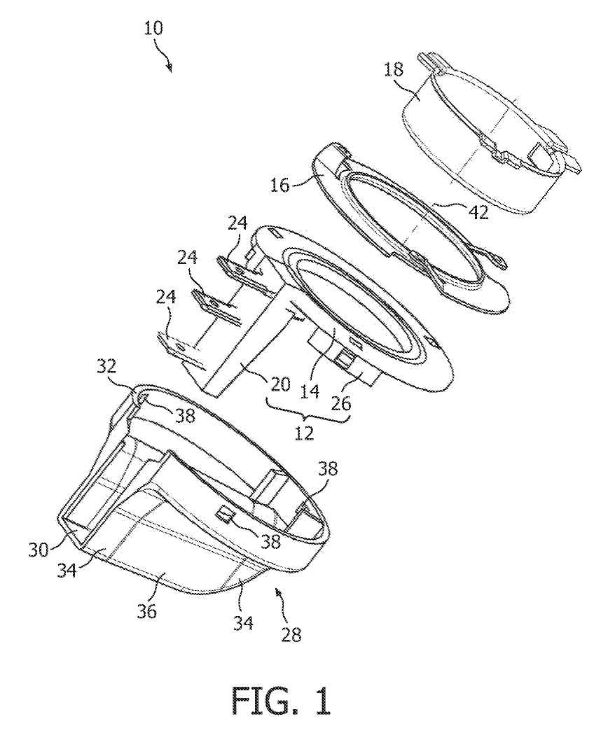

The in FIG. 1 illustrated example of the lamp 10 basically is a socket arrangement for a motor vehicle lamp, particularly of the H 15 standard. The lamp 10 comprises a socket 12 made of a plastic material like PPS. The socket 12 comprises a holding part 14 for supporting a light emitting burner. To the holding part 14 an axial spring 16 and a metal holder 18 for holding the burner may be connected. A connector part 20 protrudes from the holding part 14. The connector part 14 comprises connectors 22 in an insulating manner, whereby each connector 22 terminates into a terminal 24 protruding from the connector part 14. If so, the socket may comprise a connecting means 26 for connecting a metal cover 28 to the socket 12. Due to the metal cover 28 the shape of the lamp 10 to be received by a standardized holding recess of a motor vehicle lamp housing is only provided by the metal cover 28, so that the plastic material of the socket 12 is significantly reduced. The metal cover 28 may be manufactured by deep drawing.

The cover 28 comprises a opening, which is designed as a slot 30 terminating in an open end at an edge 32 of the cover 28. The cover 28 comprises two fastening parts 34, by which the lamp 10 may be fastened to the holding recess of a reflector housing or the like. Between the fastening parts 34 extends a cooling part 36 for providing a heat transfer from the burner via the socket 12 to the environment. The cover 28 further comprises recesses 38 for receiving the connection means 26 of the socket, so that the cover 28 may be connected to the socket 12 by clipping. Further it is possible to connect the cover 28 to the socket 12 by crimping or the cover 28 may be mould in the socket 12, so that the connecting means 26 and the recesses 38 may be omitted.

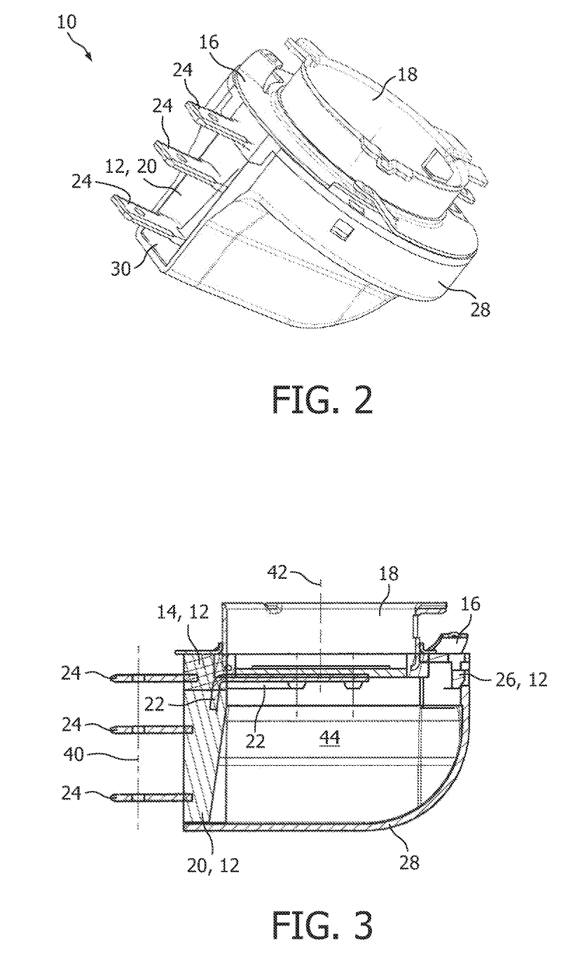

The cover 28 and the socket 12 may be put together in axial direction, so that in the assembled state of the lamp 10, as illustrated in FIG. 2, the cover 28 receive the socket 12. Since the terminals 24 are arranged one after the other in a line 40 substantially parallel to a longitudinal axis 42 of the lamp 10, a sufficient movability of the cover 28 with respect to the socket 12 is provided. Due to the slot 30 a connection of the cover 28 to the terminals 24 is avoided, so that a short current via the cover 28 is prevented. Further the cover 28 is connected to the socket 12 such, that a connection to the axial spring 16 is prevented. The cover 28 is only in direct contact to the socket 12. Thus, the electrical insulation of the cover 28 is further safeguarded. Further the contact between the cover 28 and the socket 12 is planar, so that a good heat conduction from the socket 12 to the cover 28 is provided.

As illustrated in FIG. 2 most of the surface of the plastic material of the socket 12 is covered. Thus, an out-gassing from the plastic material of the socket 12 is significantly reduced. Only surfaces in area of the slot 30 and those surfaces not covered by the axial spring 16 and/or the holder 18 are exposed to the environment. As can be seen best in FIG. 3 between the cover 28 and the socket 12 an encapsulating volume 44 is provided, by which significantly more than 60% of the surface of the plastic material of the socket 12 is encapsulated by means of the cover 28. Gases out-gassed from the plastic material of the socket 12 may condense onto the surface of the cover 28 without affecting the optical performance of the lamp 10.

While the invention has been illustrated and described in detail in the drawings and foregoing description, such illustration and description are to be considered illustrative or exemplary and not restrictive; the invention is not limited to the disclosed embodiments.

For example, it is possible to operate the invention in an embodiment wherein the socket 12 consists only of the holding part 14 and the connector part 20, so that the connecting means 26 are omitted.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. Lamp, particularly motor vehicle lamp, comprising
a socket (12) made of a plastic material,
the socket (12) comprising two or more connectors (22) electrically connectable to a burner in order to apply an electric current, and
each connector (22) comprising a terminal (24) protruding from the socket (12),
wherein a metal cover (28) is provided receiving the socket (12), wherein the cover (28) is shaped to fit into a standardized holding recess of a reflector housing and the cover (28) comprises at least one opening (30) for providing an insulating space between the cover (28) and the terminals (24).

2. Lamp according to claim 1, wherein the cover (12) encapsulates ≧60%, particularly ≧70%, preferably ≧80% and most preferred ≧85% of the surface of the socket (12).

3. Lamp according to claim 1, wherein the cover (28) is in direct contact to the plastic material of the socket (12) only.

4. Lamp according to claim 1, wherein the cover (28) is at least partially in planar contact to the socket (12).

5. Lamp according to claim 1, wherein the cover (28) comprises a cooling part (36) for transferring heat from the burner to the environment.

6. Lamp according to claim 1, wherein the opening of the cover is shaped as a slot (30) comprising an open end for providing a movability of the cover (28) substantially perpendicular to the terminals (24).

7. Lamp according to claim 1, wherein the plastic material of the socket (12) consists of a connector part (20) for fixing the connectors (22) and the terminals (24) in an insulating manner to each other, a holding part (14) for supporting directly or indirectly the burner and at least one connecting means (26) for connecting the cover (28) to the socket (12).

8. Lamp according to claim 1, wherein the plastic material of the socket (12) consists of a connector part (20) for fixing the connectors (22) and the terminals (24) in an insulating manner to each other and a holding part (14) for supporting directly or indirectly the burner.

9. Lamp according to claim 1, wherein the cover (28) is adapted to be manufactured by deep drawing.

10. Motor vehicle lamp arrangement comprising
a reflector housing, which comprises a standardized holding recess for receiving a motor vehicle lamp,
a lamp (10) according to claim 1, particularly a headlight, main beam or taillight,
wherein the reflector housing and the lamp (10) are shaped such, that the terminals (24) of the lamp (10) are adapted be come into electrical contact to the reflector housing by turning the lamp (10) after inserting the lamp (10) into the standardized holding recess.
